(19) United States
(12) Patent Application Publication
(10) Pub. No.: US 2003/0098857 A1
(43) Pub. Date: May 29, 2003

(54) Detachable flexible and expandable display with touch sensor apparatus and method

(75) Inventors: Shawn R. Gettemy, San Jose, CA (US); Kevin Lee, San Jose, CA (US); William R. Hanson, Mountain View, CA (US); Yoon Kean Wong, Redwood City, CA (US)

Correspondence Address: FOLEY & LARDNER, 777 EAST WISCONSIN AVENUE, SUITE 3800, MILWAUKEE, WI, 53202-5308, US

(73) Assignee: Palm, Inc.

(21) Appl. No.: 09/996,149

(22) Filed: Nov. 28, 2001

(51) Int. Cl. G09G 5/00

(52) U.S. Cl. 345/173

(57) ABSTRACT

A handheld computer is disclosed. The handheld computer includes a housing, and an expandable display assembly supported by the housing. The expandable display assembly provides a viewing area when the display assembly is stored and provides a larger viewing area when the expandable display assembly is expanded. A touch sensor is disclosed that is associated with the expandable display. The touch sensor is enlarged along with the display, when the expandable display is expanded.

### BACKGROUND

The invention relates generally to the field of display systems for portable electronic devices. In particular, the invention relates to display systems for portable electronic devices that include touch sensors for providing input to the portable electronic devices and where the display systems are detachable from the portable electronic devices. Further, the invention relates to detachable flexible and/or expandable displays for portable electronic systems, each flexible and/or expandable display having associated therewith a touch sensing device.

Conventionally, portable electronic devices include visible displays, such as liquid crystal displays (LCD's) and other similar displays. Such displays may be incorporated into any of a variety of portable electronic devices, such as mobile telephones, handheld computers, personal digital assistants (PDA's), laptop computers, and the like. Because it is desirable for a portable electronic device to have a relatively small form factor, it has been generally undesirable to include a large display screen. Accordingly, conventional electronic devices include displays which have a relatively small form factor and are generally smaller than the footprint of the portable electronic device itself.

Because of the small form factor, many conventional portable electronic devices also include a touch sensor which may be overlaid, underlaid, or incorporated into the display screen itself. The touch sensor is provided to enable users to provide input to the portable electronic device.

Because displays for portable electronic devices are relatively small, a number of disadvantages arise in using such devices, such as, but not limited to difficulty in reading text on the screen, difficulty in displaying pictorial or graphic images, difficulty in navigating around the screen because large amounts of scrolling may be required, difficulty in editing and formatting documents, and difficulty in displaying large amounts of information.

Accordingly, there is a need for a display system that maintains a relatively small form factor but is expandable and also maintains a touch sensor associated with and movable with the expandable display. There is also a need for a portable electronic device which includes a flexible and/or expandable display that may be detachable from the body of the device and contains a touch sensor which is movable with the flexible and/or expandable display and provides an enlarged touch sensor area when the viewing area of the flexible and/or expandable display screen is enlarged. Further, there is a need for a foldable display assembly. The portable display assembly may include a foldable electronic display surface with a touch sensor that is foldable with the foldable electronic display surface. Further still, there is a need for a handheld computer with an expandable display assembly that includes a touch sensor that is enlarged when the expandable display assembly is enlarged. The handheld computer may include a connector such that the expandable display assembly may be removed from the handheld computer while remaining in communication therewith.

It would be desirable to provide a system and/or method that provides one or more of these or other advantageous features. Other features and advantages will be made apparent from the present specification. The teachings disclosed extend to those embodiments which fall within the scope of the appended claims, regardless of whether they accomplish one or more of the aforementioned needs.

### SUMMARY

An exemplary embodiment relates to a display system. The display system is detachable from a host device. The display system includes a power source. The display system also includes a processor coupled to the power source and a memory coupled to the power source and the processor. The display system further includes a flexible electronic display coupled to the processor and the power source and a coupler for coupling the flexible electronic display to the host device. Further still, the display system includes a flexible touch sensor movable with the flexible electronic display.

Another exemplary embodiment relates to a portable electronic device. The portable electronic device includes a housing and a coupler connected to the housing. The portable electronic device also includes a flexible display screen assembly. The flexible display screen assembly is viewable when coupled to the coupler and expandable to provide a larger viewing area, at least when decoupled from the coupler. The flexible display screen assembly further includes a power source, a processor coupled to the power source, a memory coupled to the power source and the processor, and a flexible electronic display coupled to the processor and the power source. The flexible display screen assembly further includes a flexible touch sensor movable with the flexible electronic display, providing an enlarged touch sensor area when the viewing area of the flexible display screen assembly is enlarged.

Yet another exemplary embodiment relates to a foldable display assembly. The foldable display assembly includes a power source and a processor coupled to the power source. The foldable display assembly also includes a memory coupled to the power source and a foldable electronic display coupled to the processor and the power source. The foldable display assembly further includes a coupler for coupling the foldable electronic display to a host device, and a foldable touch sensor foldable with the foldable electronic display.

Yet further still, an exemplary embodiment relates to a handheld computer. The handheld computer includes a housing and an expandable display assembly supported on the housing. The expandable display assembly provides a viewing area when folded and provides a larger viewing area when expanded. The handheld computer further includes a touch sensor associated with the expandable display. The touch sensor is enlarged when the expandable display is expanded.

Yet further still, another exemplary embodiment relates to a method of using a handheld computer. The method includes viewing an image on an unenlarged viewing area of a flexible display. The method also includes providing input to the handheld computer via a touch sensor having an unenlarged sensing area associated with the flexible display. Further, the method includes enlarging the flexible display to provide an enlarged viewing area. Further still, the method includes viewing an image in the enlarged viewing area. Yet further still, the method includes providing input to the handheld computer via a touch sensor having an enlarged sensing area associated with the flexible display.

Alternative exemplary embodiments relate to other features and combination of features as may be generally recited in the claims.

### BRIEF DESCRIPTION OF THE DRAWINGS

The invention will become more fully understood from the following detailed description, in conjunction with the accompanying drawings, wherein like reference numerals refer to like elements, in which:

FIG. 1 is a block diagram of a handheld computer and a detached, enlarged display assembly;

FIG. 2 is an exemplary cross section of a display assembly depicting a display layer and a touch sensing layer;

FIG. 3 is an exemplary depiction of the flexibility of the display and touch sensor of FIG. 2;

FIG. 4 is an exemplary depiction of a foldable display such that the touch sensor layer associated with the display layer is foldable therewith;

FIG. 5 is an exemplary depiction of an alternative embodiment of a display having a touch sensor layer underlaying the display layer;

FIG. 6 is an exemplary depiction of a foldable display of FIG. 5 in a folded state;

FIG. 7 is an exemplary depiction of a handheld computer having a display in a compact or stored state;

FIG. 8 is a depiction of an exemplary display system that is folded out to provide a larger viewing area; and

FIG. 9 is an exemplary depiction of a folded display in which the display has been unfolded to provide an enlarged display area.

### DETAILED DESCRIPTION OF EXEMPLARY EMBODIMENTS

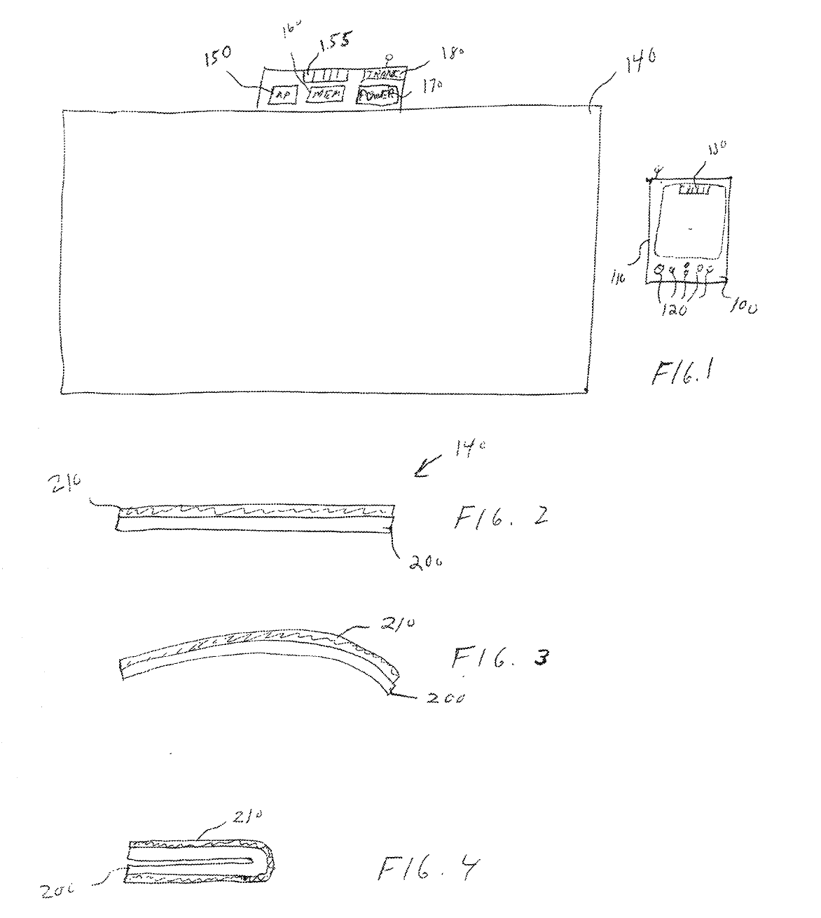

Referring to FIG. 1, a handheld computer 100 is depicted. Handheld computer 100 includes a housing 110 supporting a plurality of electronics therein and having, in an exemplary embodiment a plurality of input buttons or devices 120. Supported by housing 110 is a coupler 130. Coupler 130 may provide an apparatus or device configured to attach a display assembly thereto. Further, coupler 130 may include contacts which provide electronic coupling between handheld computer 100 and a detachable display, such as detachable display 140.

Detachable display 140 is in an exemplary embodiment, an expandable display and includes a coupler 155 configured to couple to coupler 130 of handheld computer 100. Further, display 140 includes a microprocessor 150, a memory 160, a power source 170, and a transceiver 180. When detached from handheld computer 100, display 140 may be expanded in the configuration depicted having a display area much larger than the footprint of handheld computer 100.

Display 140 may be a flexible display, a foldable display, a rollable display, or any other type of expandable or flexible displays. The flexible display may be made from any of a variety of applicable display technologies such as, but not limited to a variety of bistable displays, such as, but not limited to cholesteric, electro-phoretic, gyricon, smectic C ferro-electric, zenith bistable (ZBD), APD™ from Citala Ltd., elnk technologies from elnk Corporation, and other types of displays which may be configured in a flexible and/or foldable form.

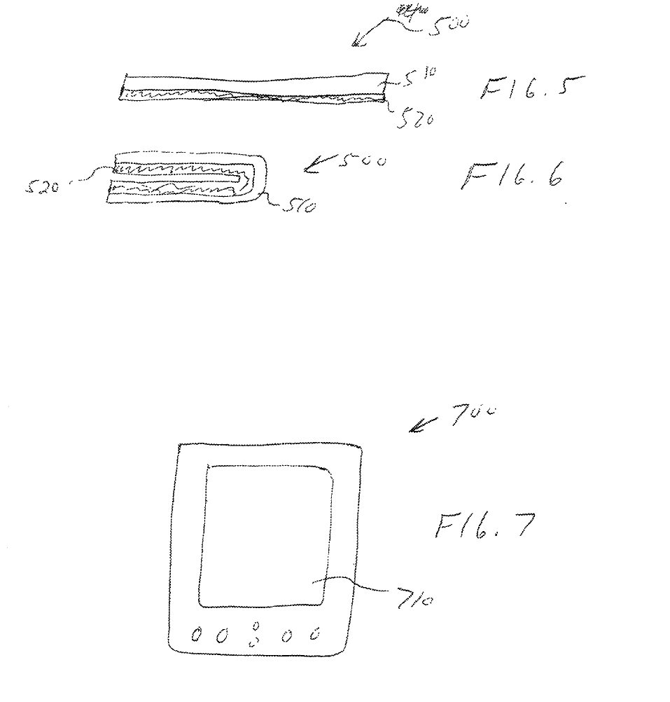

Referring now to FIG. 2, an exemplary cross sectional view of display 140 is depicted. Display 140 includes a display layer 200 that may be any type of bistable display or any other type of flexible and/or foldable displays, including displays which may include hinged sections. Overlying display layer 200 is a digitizer or touch sensor layer 210. In an exemplary embodiment, touch sensor layer 210 is adhered to, coupled to, or associated with layer 200. As depicted, touch sensor layer 210 may be a flexible touch sensor layer that is transparent so that a viewer can view display layer 200 through touch sensor layer 210. Such flexible touch sensor layers may include, but are not limited to electrodag coating layers which form transparent conductors having flexibility. As depicted in FIG. 3, touch sensor layer 210 is a flexible layer that flexes with display layer 200. In another exemplary embodiment depicted in FIG. 4, touch sensor layer 210 is foldable when display layer 200 is folded.

Referring now to FIG. 5, an alternative embodiment of a display 500 is depicted. Display 500 includes a display layer 510 which overlays a touch sensitive layer 520. Layer 520 may be any of a variety of touch sensing technologies such as, but not limited to an electrotextile layer. Electrotextile layer 520 is an alternative form of digitizer in which pressure on layer 510 is communicated through layer 510 to compress a small portion of layer 520. As layer 520 is compressed, the resistivity of the area that is compressed is changed and that change is sensed. Accordingly, the location of the compression may be determined. Referring now to FIG. 6, display 500 is depicted as being folded whereby display layer 510 is folded over electrotextile or touch sensitive layer 520.

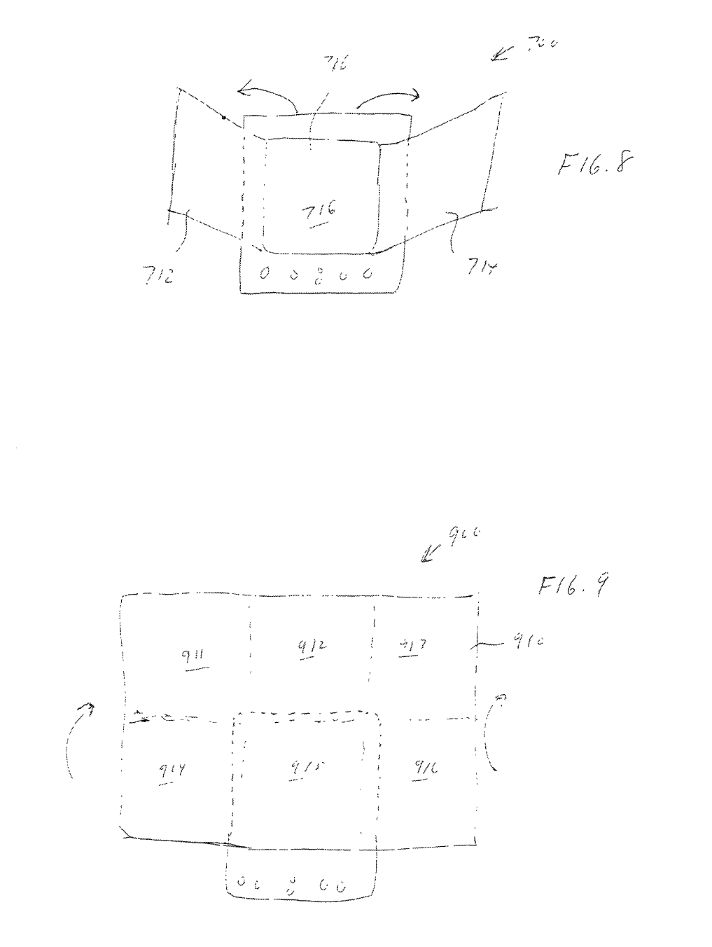

Referring now to FIG. 7, an exemplary handheld computer 700 is depicted. Handheld computer 700 includes a foldable and/or expandable display screen 710. In the state depicted in FIG. 7, display screen 710 may be used to view information in a folded or compact state as depicted in FIG. 7. In an exemplary embodiment, display 710 may be unfolded as depicted in FIG. 8. Display 710 may, in an exemplary embodiment include a plurality of folded sections each having the ability to display information thereon. In one exemplary embodiment, display 710 may have a left hand section 712 a right hand section 714 and a center section 716. Information may be displayed on any and all of sections 712, 716 and 714. Further, sections 712, 714, and 716 may be configured in the manner shown or may be configured in a flattened configuration and may include supporting structure associated therewith. Further still, folded sections 712, 714, and 716 may be separated by hinges, folds, pleats, scores, etc.

In another exemplary embodiment depicted in FIG. 9, a handheld computer 900 is depicted with a display 910 that may be unfolded to reveal six different display sections 911, 912, 913, 914, 915 and 916. Information may be displayed on any and/or all of sections 911, 912, 913, 914, 915, and/or 916. Associated with displays 710 and 910 are touch sensors overlying and/or underlying the display layers, as suggested by FIGS. 4 and 6 to provide a digitizer for a user to provide input to handheld computer 700 or 900. Further, in an alternative embodiment displays 710 and/or 910 may be configured to be separable or detachable from handheld computer 700 or 900 respectively, as depicted in FIG. 1. A touch sensor, as it is described earlier remains in association with displays 710 and 910 and may be used when the display is detached from the handheld computer. The configurations of foldable displays are not limited to those depicted in FIGS. 1-9, but may be provided in any variety of configurations and/or forms.

Referring again to FIG. 1, display 140 includes its own microprocessor 150, memory 160, power source 170, and transceiver 180 so that it can operate detached from handheld computer 100. Handheld computer 100 may also include a transceiver which communicates information to transceiver 180. In an exemplary embodiment transceiver 180 may be a Bluetooth transceiver but other types of transceivers may also be applied including infrared (IR) transceiver. Microprocessor 150 is configured with software to interpret and control the input of information through transceiver 180 and to control the movement of information to and from memory 160. Further, microprocessor 150 is configured with software to control the information displayed on display 140. In the exemplary embodiment depicted in FIG. 1, display 140 includes its own power source 170 such that the display itself may be powered along with the associated electronics, microprocessor 150, memory 160, transceiver 180, etc. Further, microprocessor 150 is used to process information relating to information received from a touch sensor overlying and/or underlying display 140, in accordance with FIGS. 2 and/or 5.

In an exemplary embodiment, a user of handheld computer, such as handheld computer 700 of FIG. 7, may view an image on an unenlarged viewing area 710 of a flexible, a foldable, and/or an expandable display. A user may be able to provide touch screen input to screen 710 because a touch sensor is available in association with display 710. However, the user of handheld computer 700 may feel that the small format of display 710 is inadequate for the task at hand. In such a case the user would enlarge the flexible display to provide an enlarged viewing area. The enlargement may be accomplished by unfolding the display, stretching the display, unrolling the display, or any other applicable method which has the result of enlarging the viewing area. Once the display area has been enlarged, a user may then be able to view an image in the enlarged viewing area. Because flexible display 710 is provided with a flexible touch sensor that is associated with the entire surface of the enlarged viewing area, a user may then provide input to the handheld computer via the touch sensor. In an exemplary embodiment, such touch input may be provided using a finger tip, a stylus, or another type of input or writing device. Further, the touch sensor may be any of a variety of types of touch sensors including, but not limited to transparent coatings, and electrotextile fabric, etc. Yet further still, the use of an enlargeable display having a touch sensor is not limited to handheld computers but may also be applied to mobile phones, laptop computers, calculators, personal digital systems, personal organizers, messaging devices, pagers, etc. Further, the display being of a flexible, enlargeable, or foldable type may be any of a variety of display types including, but not limited to bistable displays, including electronic paper (e-paper), and the like.

While the detailed drawings, specific examples and particular formulations given describe preferred and exemplary embodiments, they serve the purpose of illustration only. The inventions disclosed are not limited to the specific forms shown. For example, the methods may be performed in any of a variety of sequence of steps. The hardware and software configurations shown and described may differ depending on the chosen performance characteristics and physical characteristics of the computing devices. For example, the type of computing device, communications bus, or processor used may differ. The systems and methods depicted and described are not limited to the precise details and conditions disclosed. Furthermore, other substitutions, modifications, changes, and omissions may be made in the design, operating conditions, and arrangement of the exemplary embodiments without departing from the scope of the invention as expressed in the appended claims.

What is claimed is:

1. A display system, detachable from a host device, the display system, comprising:
a power source;
a processor coupled to the power source;
a memory coupled to the power source and the processor;
a flexible electronic display coupled to the processor and the power source;
a coupler for coupling the flexible electronic display to the host device; and
a flexible touch sensor movable with the flexible electronic display.

2. The display system of claim 1, wherein the flexible electronic display is electronic paper (e-paper).

3. The display system of claim 1, wherein the flexible display is foldable.

4. The display system of claim 1, wherein the host device is a handheld computer.

5. The display system of claim 1, wherein the flexible touch sensor includes a transparent coating.

6. The display system of claim 1, wherein the flexible touch sensor includes an electrotextile.

7. A portable electronic device, comprising: a housing;
a coupler connected to the housing; and
a flexible display screen assembly, the flexible display screen assembly being viewable when coupled to the coupler and expandable to provide a larger viewing area, at least when decoupled from the coupler, the flexible display screen assembly including,
a power source;
a processor coupled to the power source;
a memory coupled to the power source and the processor;
a flexible electronic display coupled to the processor and the power source; and
a flexible touch sensor movable with the flexible electronic display, providing an enlarged touch sensor area when the viewing area of the flexible display screen assembly is enlarged.

8. The portable electronic device of claim 7, wherein the flexible electronic display is electronic paper (e-paper).

9. The portable electronic device of claim 7, wherein the flexible display is foldable.

10. The portable electronic device of claim 7, wherein the portable electronic device is a handheld computer.

11. The portable electronic device of claim 7, wherein the flexible touch sensor includes a transparent coating.

12. The portable electronic device of claim 7, wherein the flexible touch sensor includes an electrotextile.

13. A foldable display assembly, comprising:
a power source;
a processor coupled to the power source;
a memory coupled to the power source;
a foldable electronic display coupled to the processor and the power source;
a coupler for coupling the foldable electronic display to a host device; and
a foldable touch sensor foldable with the foldable electronic display.

14. The foldable display of claim 13, wherein the foldable electronic display is electronic paper (e-paper).

15. The foldable display of claim 13, wherein coupler includes a coupler for coupling to a handheld computer.

16. The foldable display of claim 13, wherein the flexible touch sensor includes a transparent coating.

17. The foldable display of claim 13, wherein the flexible touch sensor includes an electrotextile.

18. A handheld computer, comprising:
a housing;
an expandable display assembly supported on the housing, providing a viewing area when the expandable display assembly is folded and providing a larger viewing area when the expandable display assembly is expanded; and
a touch sensor associated with the expandable display, the touch sensor being enlarged when the expandable display is expanded.

19. The handheld computer of claim 18, wherein the expandable display assembly is electronic paper (e-paper).

20. The handheld computer of claim 18, wherein the expandable display assembly is foldable.

21. The handheld computer of claim 18, wherein the portable electronic device is a handheld computer.

22. The handheld computer of claim 18, wherein the touch sensor includes a transparent coating.

23. The handheld computer of claim 18, wherein the touch sensor includes an electrotextile.

24. A method of using a handheld computer, comprising:
viewing an image on an unenlarged viewing area of a flexible display;
providing input to the handheld computer via a touch sensor having an unenlarged sensing area associated with the flexible display;
enlarging the flexible display to provide an enlarged viewing area;
viewing an image in the enlarged viewing area;
providing input to the handheld computer via a touch sensor having an enlarged sensing area associated with the flexible display.

25. The method of claim 24, further comprising:
decoupling the flexible display from the handheld computer.

26. The method of claim 24, further comprising:
providing input using a fingertip.

27. The method of claim 24, further comprising:
providing input using a stylus.
